(19) United States
(12) Patent Application Publication
(10) Pub. No.: US 2006/0042739 A1
(43) Pub. Date: Mar. 2, 2006

(54) Tire frame structure used in electromotive scooters and small size motor vehicles

(76) Inventor: Ying-Ming Yang, Changhua (TW)

Correspondence Address: Ying-Ming Yang, 235 Chung-Ho, Box 8-24, Taipei, TW

(21) Appl. No.: 10/924,128

(22) Filed: Aug. 24, 2004

(51) Int. Cl. B29D 30/00

(52) U.S. Cl. 152/427

(57) ABSTRACT

A tire frame structure used in electromotive scooters and small size motor vehicles comprises a tire frame being an integrally molding structure; a periphery round portion being formed around the periphery of the tire frame; an annular trench being formed in the periphery round portion; the annular trench having two opposite inner walls; an inner side of each inner wall having an annular protrusion for receiving the lips of a tire; a receiving space being formed between the annular protrusion and the annular trench; and an air valve hole formed in the annular trench. The air valve hole obliquely penetrating through a bottom of the annular trench toward an outer side of the tire frame.

### FIELD OF THE INVENTION

The present invention relates to tires, and particularly to a tire frame structure used in electromotive scooters and small size motor vehicles.

### BACKGROUND OF THE INVENTION

The tire frame structure used in electromotive scooters and small size motor vehicles is an important feature about the comfortableness of the passengers. In the prior art the tire frame is formed by two sheets which are screwed together so as to form a wheel frame. However, the prior art has the following elements.

The manufacturing process is complicated. The screwing process is necessary to combine the two sheets together.

Since there are two sheets, and the two sheets must be assembled, errors will generate in the manufacturing and assembly processes. As a result, the rotation of the frame is not a complete circle. Thus, when it is engaged to the tire, the tire cannot provide a comfortableness to the users.

The prior art two-sheet tire frame easily deforms due to collision since the structure is not an integral structure. Thereby, when it is combined with a tire, the air-tightness is not preferred. As a result air will leak out. Thus the prior art is not a preferred one.

### SUMMARY OF THE INVENTION

Accordingly, the primary object of the present invention is to provide a tire frame structure used in electromotive scooters and small size motor vehicles, wherein the tire frame of the present invention is formed integrally with a rigid structure which is stronger than the prior art structure assembled by screwing.

Accordingly, the main object of the present invention is to provide a tire frame structure used in electromotive scooters and small size motor vehicles, wherein the assembly work is easy. It is only necessary to engage the tire into the tire frame with a simple action. Since the tire frame is formed by single one molding process. No error or shift occurs so that a perfect circular rotation can be generated.

A further object of the present invention is to provide a tire frame structure used in electromotive scooters and small size motor vehicles, wherein the annular protrusion has an L shape inner wall for receiving the outer wall of the lip of the tire. Thus the outer wall of the lip tightly against the annular protrusion of the annular trench. No gap is formed between the tire and tire frame so that no air leakage occurs.

To achieve above objects, the present invention provides a tire frame structure used in electromotive scooters and small size motor vehicles which comprises a tire frame being an integrally molding structure; a periphery round portion being formed around the periphery of the tire frame; an annular trench being formed in the periphery round portion; the annular trench having two opposite inner walls; an inner side of each inner wall having an annular protrusion for receiving the lips of a tire; a receiving space being formed between the annular protrusion and the annular trench; and an air valve hole formed in the annular trench. The air valve hole obliquely penetrating through a bottom of the annular trench toward an outer side of the tire frame.

The various objects and advantages of the present invention will be more readily understood from the following detailed description when read in conjunction with the appended drawing.

### BRIEF DESCRIPTION OF THE DRAWINGS

FIG. 1 is an exploded view of the tire frame structure used in electromotive scooters and small size motor vehicles of the present invention.

FIG. 2 is a perspective view of the tire frame structure used in electromotive scooters and small size motor vehicles of the present invention.

FIG. 3 is a cross sectional view about the tire frame structure used in electromotive scooters and small size motor vehicles of the present invention.

FIG. 4 shows one embodiment of the tire frame structure used in electromotive scooters and small size motor vehicles of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

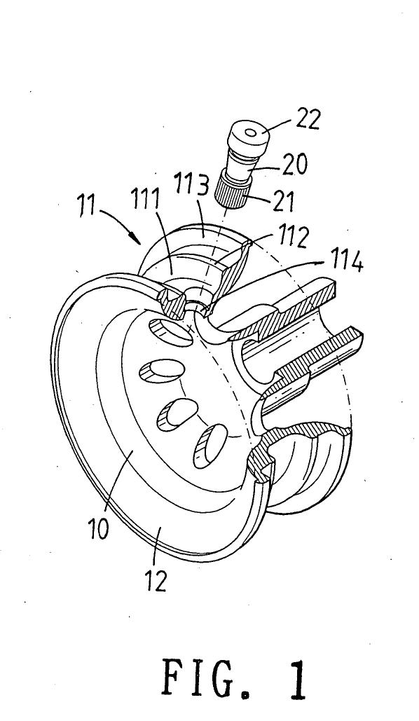

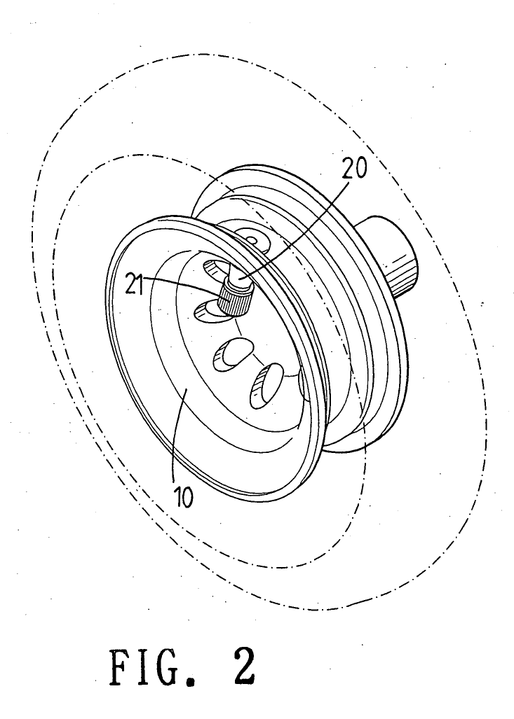

Referring to FIGS. 1 to 4, the tire frame used in electromotive scooters and small size motor vehicles of the present invention is illustrated. The tire frame has the following elements.

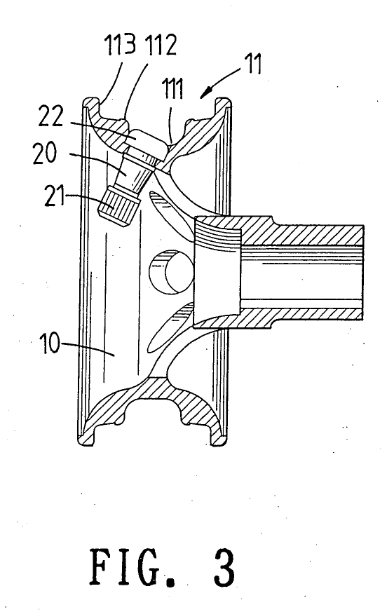

A tire frame 10, see FIGS. 1 and 3, is an integrally molding structure. A periphery round portion 11 is formed around the periphery of the tire frame 10. An annular trench 111 is formed in the periphery round portion 11. The annular trench 111 has two opposite inner walls 113. An inner side of each inner wall 113 has an annular protrusion 112 for receiving the lips 32 of a tire 30 (referring to FIG. 3).

An air valve hole 114 is formed in the annular trench 111. The air valve hole 114 obliquely penetrates through a bottom of the annular trench 111 toward an outer side of the tire frame 10; and an air valve 20 is installed in the air valve hole 114. An air outlet 22 of the air valve 20 is installed within the tire frame 10 so that air can be guided into the tire 30. An air inlet 21 of the air valve 20 is at an outer side of a sidewall 12 of the tire frame 10 so that air can be filled into the tire 30.

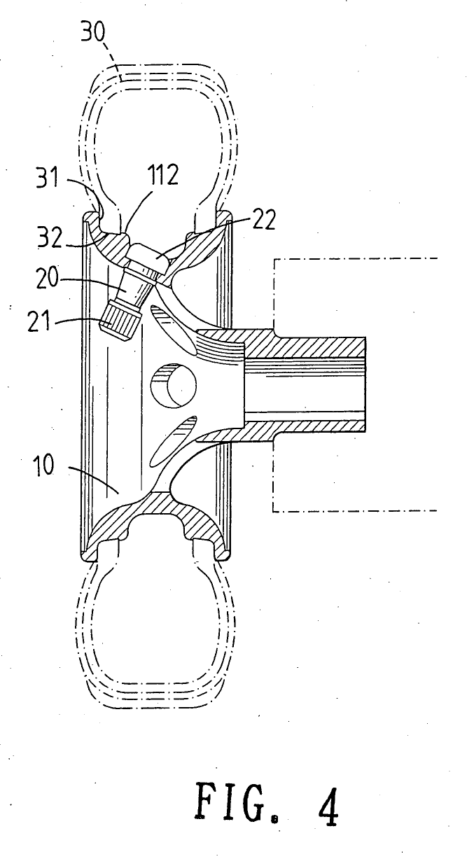

Referring to FIGS. 3 and 4, the cross sectional views of the present invention are illustrated. It is clearly that the air outlet 22 resists against the annular protrusion 112. The annular protrusion 112 has an L shape inner wall 113 for receiving the outer wall 31 of the lip 32 of the tire 30. Thus the outer wall 31 of the lip 32 tightly against the annular protrusion 112 of the annular trench 111.

Advantages of the present invention will be described in the following.

The tire frame 10 of the present invention is formed integrally with a rigid structure which is stronger than the prior art structure assembled by screwing.

The assembly work is easy. It is only necessary to engage the tire 30 into the tire frame 10 with a simple action.

Since the tire frame 10 is formed by single one molding process. No error or shift occurs so that a perfect circular rotation can be generated.

The annular protrusion 112 has an L shape inner wall 113 for receiving the outer wall 31 of the lip 32 of the tire 30. Thus the outer wall 31 of the lip 32 tightly against the annular protrusion 112 of the annular trench 111. No gap is formed between the tire 30 and tire frame 10 so that no air leakage occurs.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A tire frame structure used in electromotive scooters and small size motor vehicles comprising:
a tire frame being an integrally molding structure; a periphery round portion being formed around a periphery of the tire frame; an annular trench being formed in the periphery round portion; the annular trench having two opposite inner walls; an inner side of each inner wall having an annular protrusion for receiving tire lips at sides of an opening of a tire; a receiving space being formed between the annular protrusion and the annular trench; and
an air valve hole formed in the annular trench.

2. The tire frame structure used in electromotive scooters and small size motor vehicles as claimed in claim 1, wherein the air valve hole obliquely penetrates through a bottom of the annular trench toward an outer side of the tire frame.

3. The tire frame structure used in electromotive scooters and small size motor vehicles as claimed in claim 1, wherein an air valve is installed in the air valve hole; an air outlet of the air valve is installed within the tire frame so that air can be guided into the tire; an air inlet of the air valve is at an outer side of a sidewall of the tire frame so that air can be filled into the tire.

4. The tire frame structure used in electromotive scooters and small size motor vehicles as claimed in claim 1, wherein an air outlet resists against the annular protrusion; the annular protrusion has an L shape inner wall for receiving the outer wall of the lip of the tire; thus the outer wall of the lip tightly against the annular protrusion of the annular trench.
